(19) United States
(12) Patent Application Publication
(10) Pub. No.: US 2023/0027145 A1
(43) Pub. Date: Jan. 26, 2023

(54) K-QUANT GRADIENT COMPRESSOR FOR FEDERATED LEARNING

(71) Applicant: EMC IP Holding Company LLC, Hopkinton, MA (US)

(72) Inventor: Paulo Abelha Ferreira, Rio de Janeiro (BR)

(21) Appl. No.: 17/382,584

(22) Filed: Jul. 22, 2021

(51) Int. Cl. G06N 20/20; G06K 9/62; H04L 29/08

(52) U.S. Cl. CPC G06N 20/20; G06K 9/6298; H04L 67/10

(57) ABSTRACT

Techniques described herein relate to a method for model updating in a federated learning environment. The method may include distributing, by a model coordinator, a current model to a plurality of client nodes; receiving, by the model coordinator and in response to distributing the current model, a set of gradient K-quant vectors, wherein each gradient K-quant vector of the first set of gradient K-quant vectors is received from one client node of the plurality of client nodes. The gradient K-quant vectors may be compressed representations of gradient vectors. The compression may be performed by determining a bin index value corresponding to the gradient vector values, based on a K value and range received from the model coordinator. The model coordinator may use the gradient K-quant vectors to generate an updated model, and send the updated model to the client nodes for use in the next training cycle.

### BACKGROUND

Computing devices often exist in environments that include many such devices (e.g., servers, virtualization environments, storage devices, mobile devices network devices, etc.). Machine learning algorithms may be deployed in such environments to, in part, assess data generated by or otherwise related to such computing devices. Such algorithms may be applied to data that cannot or should not be transmitted beyond the boundaries of the environment. Such constraints on data transmission may reduce or prevent machine-learning algorithms deployed in the environment from benefitting from training of the algorithm in other environments.

### SUMMARY

In general, embodiments described herein relate to a method for model updating in a federated learning environment. The method may include distributing, by a model coordinator, a current model to a plurality of client nodes; receiving, by the model coordinator and in response to distributing the current model, a first set of gradient K-quant vectors, wherein each gradient K-quant vector of the first set of gradient K-quant vectors is received from one client node of the plurality of client nodes; generating, by the model coordinator, a first updated model based on the first set of gradient K-quant vectors; distributing the first updated model to the plurality of client nodes; storing, by the model coordinator, a plurality of shape parameters; receiving, by the model coordinator and in response to distributing the first updated model, a second set of gradient K-quant vectors, wherein each gradient K-quant vector of the second set of gradient K-quant vectors is received from one client node of the plurality of client nodes; generating, by the model coordinator, a second updated model based on the second set of gradient K-quant vectors and the plurality of shape parameters; and distributing the second updated model to the plurality of client nodes.

In general, embodiments described herein relate to a non-transitory computer readable medium that includes computer readable program code, which, when executed by a computer processor enables, the computer processor to perform a method for model updating in a federated learning environment. The method may include distributing, by a model coordinator, a current model to a plurality of client nodes; receiving, by the model coordinator and in response to distributing the current model, a first set of gradient K-quant vectors, wherein each gradient K-quant vector of the first set of gradient K-quant vectors is received from one client node of the plurality of client nodes; generating, by the model coordinator, a first updated model based on the first set of gradient K-quant vectors; distributing the first updated model to the plurality of client nodes; storing, by the model coordinator, a plurality of shape parameters; receiving, by the model coordinator and in response to distributing the first updated model, a second set of gradient K-quant vectors, wherein each gradient K-quant vector of the second set of gradient K-quant vectors is received from one client node of the plurality of client nodes; generating, by the model coordinator, a second updated model based on the second set of gradient K-quant vectors and the plurality of shape parameters; and distributing the second updated model to the plurality of client nodes.

In general, embodiments described herein relate to a system for model updating in a federated learning environment. The system may include a model coordinator, executing on a processor comprising circuitry. The model coordinator may be configured to distribute a current model to a plurality of client nodes; receive, in response to distributing the current model, a first set of gradient K-quant vectors, wherein each gradient K-quant vector of the first set of gradient K-quant vectors is received from one client node of the plurality of client nodes;

generate a first updated model based on the first set of gradient K-quant vectors; distribute the first updated model to the plurality of client nodes; store a plurality of shape parameters; receive, in response to distributing the first updated model, a second set of gradient K-quant vectors, wherein each gradient K-quant vector of the second set of gradient K-quant vectors is received from one client node of the plurality of client nodes; generate a second updated model based on the second set of gradient K-quant vectors and the plurality of shape parameters; and distribute the second updated model to the plurality of client nodes.

Other aspects of the embodiments disclosed herein will be apparent from the following description and the appended claims.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1A shows a diagram of a system in accordance with one or more embodiments of the invention.

FIG. 1B shows a diagram of a model coordinator in accordance with one or more embodiments of the invention.

FIG. 2 shows a flowchart in accordance with one or more embodiments of the invention.

FIG. 3 shows a computing system in accordance with one or more embodiments of the invention.

### DETAILED DESCRIPTION

Specific embodiments will now be described with reference to the accompanying figures.

In the below description, numerous details are set forth as examples of embodiments described herein. It will be understood by those skilled in the art (who also have the benefit of this Detailed Description) that one or more embodiments of embodiments described herein may be practiced without these specific details, and that numerous variations or modifications may be possible without departing from the scope of the embodiments described herein. Certain details known to those of ordinary skill in the art may be omitted to avoid obscuring the description.

In the below description of the figures, any component described with regard to a figure, in various embodiments described herein, may be equivalent to one or more like-named components described with regard to any other figure. For brevity, descriptions of these components may not be repeated with regard to each figure. Thus, each and every embodiment of the components of each figure is incorporated by reference and assumed to be optionally present within every other figure having one or more like-named components. Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

In general, embodiments described herein relate to methods, systems, and non-transitory computer readable mediums storing instructions for training models (e.g., machine learning algorithms) using, and that will be used by, various nodes that are operatively connected to a model coordinator. In one or more embodiments, a node (e.g., a client node) is any set of one or more computing devices (or portions therein) that are operatively connected to one another, on which one or more models are being used to predict outputs/outcomes based on input data.

There may be any amount of such input data organized in any way to contribute to variables/factors that may be assessed or otherwise used by a model. In one or more embodiments, prior to using a given version of a model, the model must be trained using a training data set. In one or more embodiments, a training data set exists on and/or is otherwise obtained by client nodes that relates to a given set of one or more outcomes that are to be predicted. For example, a given client node may have data relating to facial recognition, software use, browsing behavior, storage device performance, storage backup performance, mobile device use, battery life, self-driving automobile data, etc.

In one or more embodiments, a model coordinator is operatively connected to any number of client nodes, each having a data set for which a given model may be relevant. In one or more embodiments, a model coordinator may distribute a model to any or all of the client nodes to be trained using data present on or otherwise available to the client nodes. For example, each node may have available a data set that includes inputs coupled to resulting outputs that are known to be correct (i.e., a training and validation data set). At least a portion of such a data set for a given client node may be used to train a model (e.g., machine learning algorithm) to more correctly predict any number of outputs based on any number of inputs (e.g., future inputs for which the output is not already known). For example, if the node is arranged as a neural network with any number of layers, a backpropagation algorithm may be used, such as a gradient descent algorithm, to train the neural network to predict future outcomes based on future inputs.

In such an algorithm, an initial model is used to set initial weights assigned to interconnections between components in different layers of the network. In one or more embodiments, the training data will be used with the algorithm starting at the output layer, and propagating back through the network one layer at a time until the input layer is reached, calculating the gradients (e.g., derivatives) along the way, which are used to inform the weights assigned to the variables/factors of the function being analyzed by the algorithm.

In one or more embodiments, the outcome of such training is a gradient vector, with a value (i.e., a gradient, which may be considered a partial derivative of the function for a given variable/factor) corresponding to each variable, arranged as a vector. In one or more embodiments, each variable gradient value is located at a specific place (i.e., index location) within the gradient vector, and may be a positive or negative real number value.

In one or more embodiments, training of a model within a given client node may result in a model that fits well for the data set of that node, but that may not generalize as well to data sets for which the outcome is not already known and/or are available to other client nodes. In one or more embodiments, such a scenario is referred to as overfitting. Accordingly, it may be advantageous to aggregate the results from a number of different client nodes using the same model for their own data sets to determine a model that generalizes well to new data sets related to the same problem or data type.

In one or more embodiments, such an aggregated model may be achieved via a federated learning model. In one or more embodiments, in a federated learning model, a model coordinator operatively connected to each client node in the federation of client nodes receives results of the training from the client nodes, and uses the aggregate set of results to update a central model, which is then re-distributed to the client nodes for further training and/or use. In one or more embodiments, the process is repeated until a given training session is complete, and each client node has a copy of the model produced by the model coordinator during the training session. In one or more embodiments, the use of training results from more than one client node increases the likelihood that the resulting model will be able to correctly predict outputs for a set of future inputs obtained by each client node. Said another way, the resulting model may generalize well.

In one or more embodiments, the client nodes are each provided with a current model from the model coordinator (which may be randomized if the cycle is an initial cycle). Each client node receiving the current model from the model coordinator may then train the model using its own local training data. In one or more embodiments, the results of the training of each nodes are gradient vectors.

However, certain scenarios may exist where the actual values of a gradient vector produced from a model training cycle on a given one or more client nodes cannot (or should not) be shared with the model coordinator. Examples of such scenarios include, but are not limited to, low network bandwidth, data privacy concerns, energy constraints, etc. Additionally, the model training results from any given client node may detract from the ability of the updated model generated by the model coordinator to generalize to future data sets as a result of overfitting to the training data set of the client node.

One or more embodiments described herein address, at least in part, the aforementioned challenges by having client nodes communicate a gradient K-quant vector instead of a gradient vector to the model coordinator. In one or more embodiments, the gradient K-quant vector is a vector of values that represent the actual gradient values modified based on a K value, and a minimum and maximum range value that the model coordinator previously communicated to each client node participating in the federated learning scheme. In one or more embodiments, the minimum and maximum values may be any values that a user desires as a range. As an example, the range may be from negative one to positive one. In such an example, normalization may be required on the gradient values produced by a client node to transform the gradient values to be within the range provided by the model coordinator. In one or more embodiments, the K value defines how many bins exist within the range. In one or more embodiments, the range is divided into K equal sized sub-portions, which are referred to herein as bins.

In one or more embodiments, instead of transmitting a gradient vector to the model coordinator, each client compresses the amount of information to be transmitted to the model coordinator by transforming its gradient vector into a gradient K-quant vector. In one or more embodiments, a gradient K-quant vector uses a number of bits to represent a bin number of the bin that a given gradient value (or normalized gradient value) falls within.

As discussed above, in one or more embodiments, the number of bins is equivalent to a configurable value K, and each bin is one of K sub-portions of a possible range of values between a minimum and maximum gradient value, potentially after the gradient values have been normalized to be within a desired numerical range. As an example, gradient values produced by a client node when training a machine learning (ML) model may be normalized to be values between negative one and positive one. A K value of four may be selected for use in compressing the gradient values. As a result, the range of negative one to positive one is divided into four equal sub-portions (e.g., [−1, −0.5], [−0.5, 0], [0, 0.5], and [0.5, 1]).

In such an example, after training an ML model, and producing a gradient vector, a client node assesses each gradient value of the gradient vector, and determines which bin range it falls within. In one or more embodiments, each bin is assigned an index value. For example, when K is four, there are four bins, with index values of zero, one, two, and three. In one or more embodiments, once the client node determines which bin range a gradient vector value is within, the client node replaces the actual gradient vector value in the gradient vector with the index value associated with the bin range. As an example, when K is four, bin range [0, 0.5] has a bin index value of two. As an example, when a client node assesses an actual gradient value of 0.2, the client node determines that the gradient value is within the bin range of [0, 0.5], and thus replaces the gradient value with the bin index value of two.

In one or more embodiments, the process described above of replacing gradient values of a gradient vector with bin index numbers is performed by a client node for each gradient value in the gradient vector produced during ML model training. In one or more embodiments, each client node does the same. In one or more embodiments, each client node then transmits the resulting gradient K-quant vector to the model coordinator

In one or more embodiments, a set of one or more binary digits is used to represent the bin index value. In one or more embodiments, the number of bits required to represent a bin index number may be a number of bits required to represent the decimal value of K minus 1. As an example, when K is eight, eight minus one is seven, and three binary bits are required to represent the eight bin index values from zero to seven.

In one or more embodiments, a gradient K-quant vector effectively eliminates the transmission of any actual data from the client nodes, and instead the model coordinator only receives a portion of the results of the training of the model on the client nodes. Additionally, transmission of the bin index values rather than the actual gradient values reduces the amount of data being sent, and thereby the network bandwidth necessary to transmit the results. In one or more embodiments, the amount of data being sent from the client nodes to the model coordinator is achieved by transmitting only the number of bits needed to represent a bin index value for a given position in a gradient K-quant vector instead of the actual gradient value, which decreases the amount of information that is transmitted from the client nodes to the edge node by a compression ratio of [number of bits to represent gradient value]/[log₂K]. As an example, if gradient values would normally be communicated using a 32 bit float number, then the compression ratio achieved using embodiments described herein for transmitting the results of the ML model training in a gradient K-quant vector is 32/[log₂K]. In one or more embodiments, the lower the K value used, the higher the compression ratio (i.e., less data is transmitted). However, in one or more embodiments, lower K values result in values of the gradient K-quant vector being a less faithful representation of the gradient vector value that are produced by the model coordinator when the gradient K-quant vector is decompressed. As will be explained further below, increasing the K value used in the federated learning scheme decreases the amount of compression, but may increase the accuracy of the model generated by the model coordinator using the gradient K-quant vector.

In one or more embodiments, such a compression scheme may be referred to as K-quant compression. In one or more embodiments, K-quant compression reduces the amount of information being transmitted, and results in a similar or at least acceptable level of prediction accuracy as the actual gradient vector having been sent.

In one or more embodiments, the client nodes transmit the gradient K-quant vectors to the model coordinator. In one or more embodiments, the model coordinator aggregates the model updates and uses them to generate an updated model. In one or more embodiments, one such execution of federated learning is referred to as a cycle. In one or more embodiments, the training continues for a pre-defined number of cycles, or until some level of correct outcome prediction ability is achieved. In one or more embodiments, the set of cycles is a training session for the model, which may also be referred to as an epoch.

In one or more embodiments, the gradient K-quant vectors from the client nodes are received by the model coordinator. In one or more embodiments, the model coordinator decompresses the gradient K-quant vector. In one or more embodiments, the decompression includes replacing the bin index value at each position within the gradient K-quant vector from each client node with the mean of the upper and lower values of the bin range represented by the bin index number. As an example, if K is eight, and the range is from negative one to positive one, then a bin index value of seven represents the eighth bin. In such an example, the eighth sub-portion of the range from negative one to positive one is [0.75, 1], and the mean of that range (i.e., [0.75+1]/2) is 0.875, which becomes the uncompressed value for a gradient represented by 111 (i.e., index value 7) becomes 0.875

In one or more embodiments, the model coordinator then takes the decompressed value at each position within the vectors from the client nodes, and determines an average value for the set of decompressed values at each position. As an example, if there are ten client nodes, then the model coordinator receives ten gradient K-quant vectors. After decompressing the bin index value at each position in each vector, the resulting ten values in a given position in the vectors (e.g., the first position) are averaged to produce an aggregated mean value for that position. In one or more embodiments, the resulting set of averages for each vector value position represents an updated model, which may be distributed by the model coordinator to the client nodes for continued training, or for use if the training has completed (e.g., the epoch has ended).

When performing federated learning, there are at least two factors that are important factors in assessing how well the learning is performing. One factor is strong generalization. A good federating learning scheme will tend to produce a model that will generalize well to more correctly predict outcomes based on previously unseen inputs. Another factor is the convergence time. Convergence time may be considered the time (e.g., number of cycles, epochs, etc.) it takes to train a model to an acceptable level of performance, such as predicting outcomes within an error range. Achieving faster convergence is advantageous for a variety of reasons. One such reason, especially in a federated learning environment, is that faster convergence time means less resources and/or time are required to be used by client nodes to train the model before obtaining a model that can be used to predict whatever outcome(s) are to be predicted via use of the trained model.

Embodiments described herein may improve generalization over existing federated learning techniques, while at the same time demonstrating faster convergence times.

In one or more embodiments, a model coordinator in a federated learning environment distributes an initial model to a set of client nodes. In one or more embodiments, each client node trains the model using a data set available to the client node. In one or more embodiments, the result of the training is a gradient vector. In one or more embodiments, each client node then compresses the gradient vector to a gradient K-quant vector, and transmits the same to the model coordinator. In one or more embodiments, after receiving the gradient K-quant vectors from the client nodes, the model coordinator decodes the gradient K-quant vectors to have bin index numbers for each gradient vector position from each client node. In one or more embodiments, after decoding, for a given position within the gradient vector, the model coordinator has a set of bin index values. In one or more embodiments, the model coordinator uses the set of bin index values to determine a mean value of the range associated with the bin index value for each position of the vector. For each gradient vector position, the set of mean values are averaged to produce a single gradient vector. The result (i.e., the single gradient vector) is an updated model, which is then distributed to the client nodes for use in the next training cycle.

In one or more embodiments, the model coordinator also stores shape parameter values. In one or more embodiments, a shape parameter is a value that determines, at least in part, the shape of a curve representing the probability distribution of the K-quant representations of the gradients produced by the client nodes for a given vector position. In one or more embodiments, a distribution is parameterized by shape parameters, (e.g., a₁, a₁, a₁, etc.) In one or more embodiments, these shape parameters may be used, along with the results of the next cycle of training, to determine an expected value for each vector position in the next updated model, instead of merely performing the same determination of a mean value for each position. Said another way, embodiments described herein use the shape parameters from the previous cycle (i.e., prior shape parameters) when generating an updated model after a current cycle, and for updating the shape parameters based on the current cycle (i.e., posterior shape parameters), which become the prior shape parameters for the next cycle.

Updated shape parameters may be determined using prior shape parameters and the bin index values the gradient K-quant vector values at a given position within the gradient K-quant vectors received from the client nodes. As an example, when K is two, there are two possible bin index values, zero and one. In such an example, there may be two shape parameters, alpha (a) and beta (b). In one or more embodiments, updated shape parameters for such a distribution may be calculated as follows:

aₚ=aᵣ+S₁

bₚ=bᵣ+S₀

where:
aₚ=the updated (i.e., posterior) a shape parameter value;
bₚ=the updated (i.e., posterior) b shape parameter value;
aᵣ=the a value from the previous cycle (i.e., prior);
bᵣ=the b value from the previous cycle (i.e., prior);
S₁=the number of values of a given bin index value within the set of values for a given gradient K-quant vector position (e.g., the “ones”);
S₀=the number of values of the other bin index values within the set of values for a given gradient K-quant vector position (e.g., the “zeros”); and
N=S₀+S₁=the total number of values used at a given vector position from the gradient K-quant vectors from the client nodes.

In one or more embodiments, updating the shape parameters based on the prior shape parameters and the current cycle results may be referred to as a Bayesian update. In one or more embodiments, the results of the Bayesian update may be used to determine a value (shown below as q) at a given position to use in a model update based on the last cycle of training performed, as shown by the following calculation (for the example of K=2):

q=(aₚ−1)/(aₚ+bₚ−2)
using the equations above for aₚ and bₚ and N=S₀+S₁

q=(aᵣ+S₁−1)/(aᵣ+bᵣ+N−2)

In one or more embodiments, after the first cycle, the model coordinator may use a value of one for all shape parameters for all gradient vector positions to calculate the values at each position for an updated model. In one or more embodiments, using shape parameter values of one and the above equation for q yields q=S₁/N, which may be referred to as the maximum likelihood estimation (MLE) of a given bin index value. The expected value for the actual value for the position may be calculated as (2×q)−1.

In one or more embodiments, for the next cycle, the number of instances of each bin index value is added to one (the a used with the results of the first cycle) to become updated shape parameter values, which are used to calculate a new value (i.e., q) for a position within the new model update to be distributed to the client nodes. In one or more embodiments, the calculation is performed for each position within the gradient K-quant vectors to produce expected values for the new model update. In one or more embodiments, this calculation is repeated for each subsequent cycle, using the results of the cycle (i.e., the gradient K-quant vectors) and the shape parameter values from the previous cycle to continue producing new model updates.

In one or more embodiments, faster convergence may be achieved by introducing a limit on the number of Bayesian updates performed in this manner before re-setting the shape parameter values to one. For example, when K is two, a Bayesian update for a set of ten cycles may be performed, and then the process begins again by using a and b values (i.e., the shape parameters) of one for the 11^{th} cycle, thereby starting a new set of ten cycles. In one or more embodiments, the process continues until a training epoch completes.

In one or more embodiments, using a K-quant compression scheme achieves a reduction in amount of data being transferred, as well as eliminating the need to transmit actual data from the client nodes (e.g., the actual gradient values). In one or more embodiments, applying a Bayesian update scheme based on the gradient K-quant vectors received from the client nodes achieves stronger generalization and faster compression than merely using compression with mean aggregation techniques.

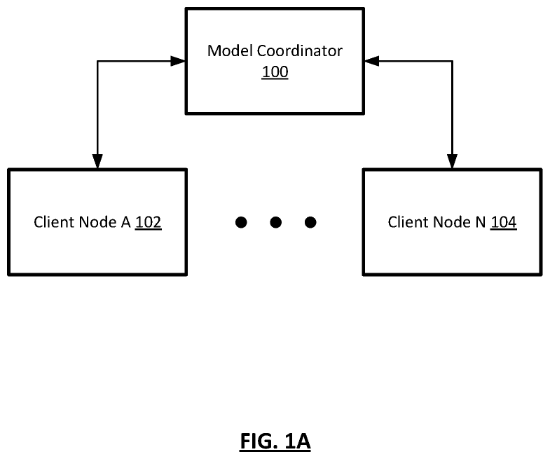

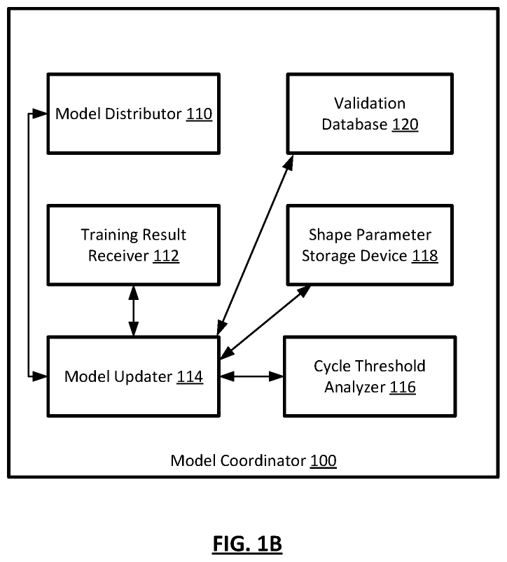

FIG. 1A shows a diagram of a system in accordance with one or more embodiments described herein. The system may include a model coordinator (100) operatively connected to any number of client nodes (e.g., client node A (102), client node N (104)). Each of these components is described below.

In one or more embodiments, the client nodes (102, 104) may be computing devices. In one or more embodiments, as used herein, a client node (102, 104) is any computing device, collection of computing devices, portion of one or more computing devices, or any other logical grouping of computing resources (e.g., a neural network).

In one or more embodiments, a computing device is any device, portion of a device, or any set of devices capable of electronically processing instructions and may include, but is not limited to, any of the following: one or more processors (e.g. components that include integrated circuitry) (not shown), memory (e.g., random access memory (RAM)) (not shown), input and output device(s) (not shown), non-volatile storage hardware (e.g., solid-state drives (SSDs), hard disk drives (HDDs) (not shown)), one or more physical interfaces (e.g., network ports, storage ports) (not shown), any number of other hardware components (not shown), and/or any combination thereof.

Examples of computing devices include, but are not limited to, a server (e.g., a blade-server in a blade-server chassis, a rack server in a rack, etc.), a desktop computer, a mobile device (e.g., laptop computer, smart phone, personal digital assistant, tablet computer, automobile computing system, and/or any other mobile computing device), a storage device (e.g., a disk drive array, a fibre channel storage device, an Internet Small Computer Systems Interface (iSCSI) storage device, a tape storage device, a flash storage array, a network attached storage device, etc.), a network device (e.g., switch, router, multi-layer switch, etc.), a virtual machine, a virtualized computing environment, a logical container (e.g., for one or more applications), and/or any other type of computing device with the aforementioned requirements. In one or more embodiments, any or all of the aforementioned examples may be combined to create a system of such devices, which may collectively be referred to as a computing device or client node (102, 104). Other types of computing devices may be used without departing from the scope of the invention.

In one or more embodiments, the non-volatile storage (not shown) and/or memory (not shown) of a computing device or system of computing devices may be one or more data repositories for storing any number of data structures storing any amount of data (i.e., information). In one or more embodiments, a data repository is any type of storage unit and/or device (e.g., a file system, database, collection of tables, RAM, and/or any other storage mechanism or medium) for storing data. Further, the data repository may include multiple different storage units and/or devices. The multiple different storage units and/or devices may or may not be of the same type or located at the same physical location.

In one or more embodiments, any non-volatile storage (not shown) and/or memory (not shown) of a computing device or system of computing devices may be considered, in whole or in part, as non-transitory computer readable mediums storing software and/or firmware.

Such software and/or firmware may include instructions which, when executed by the one or more processors (not shown) or other hardware (e.g. circuitry) of a computing device and/or system of computing devices, cause the one or more processors and/or other hardware components to perform operations in accordance with one or more embodiments described herein.

The software instructions may be in the form of computer readable program code to perform methods of embodiments as described herein, and may, as an example, be stored, in whole or in part, temporarily or permanently, on a non-transitory computer readable medium such as a compact disc (CD), digital versatile disc (DVD), storage device, diskette, tape storage, flash storage, physical memory, or any other non-transitory computer readable medium.

In one or more embodiments, the system also includes a model coordinator (100). In one or more embodiments, the model coordinator (100) is operatively connected to the client nodes (102, 104). A model coordinator (100) may be separate from and connected to any number of client nodes (102, 104). In one or more embodiments, the model coordinator (100) is a computing device (described above). The model coordinator (100), and components therein, are discussed further in the description of FIG. 1B, below.

In one or more embodiments, the client nodes (102, 104) and the model coordinator (100) are operatively connected via a network (not shown). A network may refer to an entire network or any portion thereof (e.g., a logical portion of the devices within a topology of devices). A network may include a datacenter network, a wide area network, a local area network, a wireless network, a cellular phone network, or any other suitable network that facilitates the exchange of information from one part of the network to another. A network may be located at a single physical location, or be distributed at any number of physical sites. In one or more embodiments, a network may be coupled with or overlap, at least in part, with the Internet.

While FIG. 1A shows a configuration of components, other configurations may be used without departing from the scope of embodiments described herein. Accordingly, embodiments disclosed herein should not be limited to the configuration of components shown in FIG. 1A.

FIG. 1B shows a diagram of a model coordinator (100) in accordance with one or more embodiments described herein. The model coordinator (100) may include any number of components. As shown in FIG. 1B, the model coordinator (100) includes a model distributor (110), a training result receiver (112), a model updater (114), a cycle threshold analyzer (116), a shape parameter storage device (118), and a validation database (120). Each of these components is described below.

In one or more embodiments, a model coordinator (100) is a computing device, as discussed above in the description of FIG. 1A.

In one or more embodiments, the model coordinator (100) includes a model distributor (110). In one or more embodiments, a model distributor (110) is any hardware (e.g., circuitry), software, firmware, or any combination thereof that includes functionality to distribute models (e.g., initial models, updated models) generated by the model coordinator (100). In one or more embodiments, such a model may be transmitted via one or more network interfaces (not shown), and may be distributed on a recurring basis as part of a model training session. In one or more embodiments, the model distributed may be a gradient vector representing the results of aggregating model updates (i.e., gradient K-quant vectors) received from client nodes. In one or more embodiments, the model distributor (110) may also distribute any other information relevant to the model being distributed. Examples of such additional information include, but are not limited to, the K value to be used, and the minimum and maximum values of the range to be used (which the client nodes will divide into K equal sub-portions for determining bin index values).

In one or more embodiments, the model coordinator (100) includes a training results receiver (112). In one or more embodiments, training results receiver (112) is any hardware (e.g., circuitry), software, firmware, or any combination thereof that includes functionality to obtain/receive model updates (i.e., gradient K-quant vectors) from client nodes. In one or more embodiments, model updates are obtained in any manner capable of collecting data from or about computing devices (e.g., via, at least in part, one or more network interfaces of the model coordinator (100)).

Such model updates may include, from any number of client nodes, gradient K-quant vectors that are a representation of the results of the model training performed by the client nodes. As described above, a gradient K-quant vector may be a vector with a set of bit values, each representing the bin index value of one of the gradients of the gradient vector resulting from a model training cycle performed by a client node.

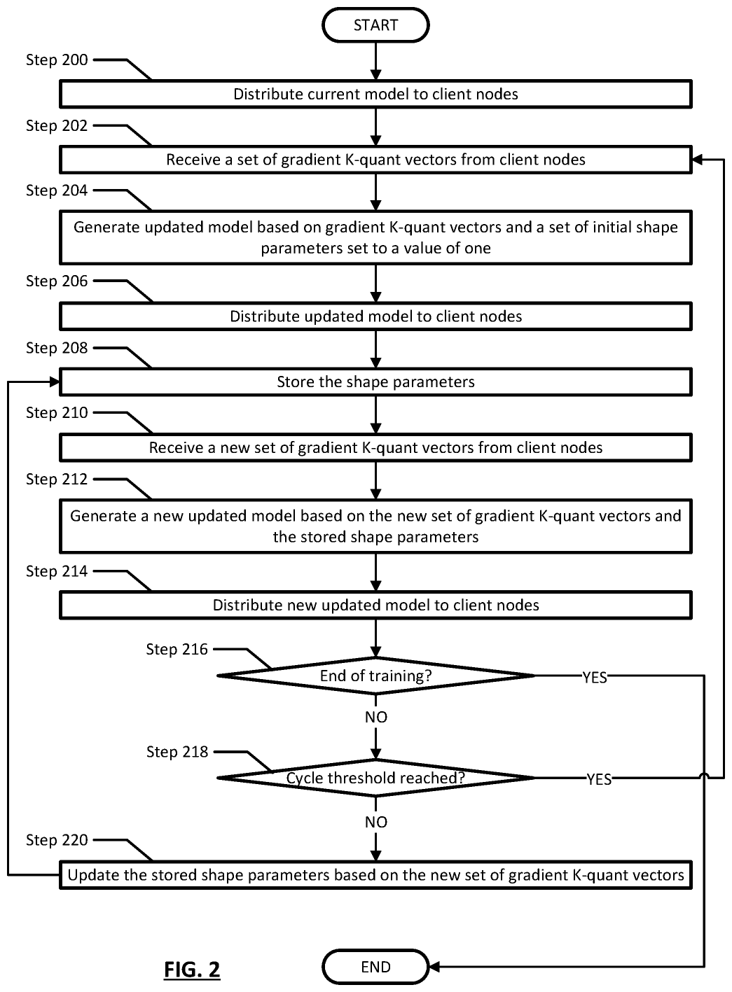

In one or more embodiments, the model coordinator (100) includes a model updater (114) operatively connected to the aforementioned model distributor (110) and the training results receiver (112). In one or more embodiments, a model updater (114) is any hardware (e.g., circuitry), software, firmware, or any combination thereof that includes functionality to use model updates received via the training results receiver (112) to update a model during a training session to be distributed back to client nodes via a model distributor (110). In one or more embodiments, updating a model includes assessing a set of model updates, assessing the positions within the gradient K-quant vectors that represent the model updates, and, for each position, using the values of that position in the various gradient K-quant vectors and initial or updated shape parameters (e.g., a and b) to generate a model update. The function of the model updater (114) is discussed further in the description of FIG. 2, below.

In one or more embodiments, the model coordinator (100) includes a cycle threshold analyzer (116) operatively connected to the model updater (114). In one or more embodiments, a cycle threshold analyzer (116) is any hardware (e.g., circuitry), software, firmware, or any combination thereof that includes functionality to determine if a pre-set or configured threshold of cycles since the last time the model updater (114) used the initial shape parameter values have occurred. In one or more embodiments, if the cycle threshold has been reached, the cycle threshold analyzer (116) indicates to the model updater to use the initial shape parameters for the next cycle of the training epoch. As an example, if the cycle threshold is twenty, then after every twenty cycles, the cycle threshold analyzer may indicate to the model updater (114) to use shape parameter values of one for the next cycle when determining values for the model update based on that cycle.

In one or more embodiments, the model updater (114) is also operatively connected to a shape parameter storage device (118). In one or more embodiments, a shape parameter storage device is data storage of any type (e.g., a data repository, as described above), of a computing device (described above) that may be used to store initial shape parameter values and updated shape parameter values that have been updated based on a Bayesian update using the shape parameters from the previous cycle and the model updates (i.e., gradient K-quant vectors) of the current cycle.

In one or more embodiments, a validation database (120) is data storage of any type (e.g., a data repository, as described above), that is configured to store information that may be used in performing an analysis for a given model (e.g., an updated model provided by the model updater (114). Such information may include the results of past validation losses determined for previous iterations of a model, which may be used in a regression analysis to fit a curve to the validation losses and check the value of the slope of the curve. In one or more embodiments, the slope of the curve determines whether or not the model is generalizing well (i.e., whether or not it is overfitting the data).

While FIG. 1B shows a configuration of components, other configurations may be used without departing from the scope of embodiments described herein. For example, although FIG. 1B shows all components as part of the same device, any of the components may be grouped in sets of one or more components which may exist and execute as part of any number of separate and operatively connected devices. As another example, a single component may be configured to perform all or any portion of the functionality performed by the components shown in FIG. 1B. Accordingly, embodiments disclosed herein should not be limited to the configuration of components shown in FIG. 1B.

FIG. 2 shows a flowchart describing a method for ML model training in a federated learning environment in accordance with one or more embodiments disclosed herein.

While the various steps in the flowchart shown in FIG. 2 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel with other steps of FIG. 2.

In Step 200, a current model is distributed by a model coordinator to client nodes. In one or more embodiments, as described above, a model may be represented as a vector of values corresponding to a set of variables of a gradient vector. In one or more embodiments, if the current model is the initial model the values therein may be randomly initialized. In one or more embodiments, thereafter, during a training session, each subsequently distributed current model is an updated model generated as a result based on the gradient K-quant vectors received from client nodes during a cycle of the training session. In one or more embodiments, the same current model is distributed to each of the client nodes. In one or more embodiments, the client nodes use their own data to train the current model, which results in a gradient vector.

In Step 202, the model coordinator receives model updates from the client nodes. In one or more embodiments, the model updates are based on the gradient vectors generated by the client nodes after training the current model received in Step 200 using their data. The model update may be a gradient K-quant vector that includes a set of bit values representing the bin index values of the gradients in the gradient vector.

In Step 204, an updated model is generated using the gradient K-quant vectors from the client nodes. In one or more embodiments, updating the model to obtain an updated model includes, for each gradient K-quant vector position, obtaining the set of values at that position from each of the gradient K-quant vectors. The values may be decoded to bin index values. For example, when K is four, two bits are used to represent the bin index value. In such an example, 00 may be decoded to zero, 01 may be decoded to one, 10 may be decoded to two, and 11 may be decoded to three. In one or more embodiments, using the bin index values, the model coordinator replaces the bin index value with the average of the sub-portion range associated with the bin index value. Continuing the example where K is four, where the overall range is negative one to one, the sub-portion ranges are [−1, −0.5], [−0.5, 0], [0, 0.5], and [0.5, 1]. Thus, the mean range values are −0.75, −0.25, 0.25, and 0.75, respectively, for the four sub-portions, and the bin index values of the gradient K-quant vector are replaced with the relevant mean values associated with the bin index values. In one or more embodiments, using distribution shape parameters of one, a value is determined for each vector position, which is equivalent to finding the mean of the values for that position.

For example, when K is two, for twenty gradient K-quant vectors, vector position three may have twelve bin index values of one and eight bin index values of zero. Using shape parameters of one, the equation for q (the expected value to use as the result for the position) becomes S₁/N, where, in this example, S¹ is the number of bin index values of one, and N is the total number of client nodes and, therefore, gradient K-quant vectors from which values are used. Therefore, the value to be used as q is 12/20=0.6. (2×0.6)−1=0.2, which is the expected value in the updated model at vector position three.

In one or more embodiments, the above-described analysis is performed to determine an expected value for each vector position, and the results are used to form a model update.

In Step 206, the updated model obtained in Step 204 is distributed to the client nodes. In one or more embodiments, the client nodes each use the updated model to perform another training cycle, each using client data available to that client node.

In Step 208, the model coordinator stores the shape parameters used in the calculation in Step 204, which at this point are one for each shape parameter at each position.

In Step 210, a new set of gradient K-quant vectors are received at the model coordinator from the client nodes, representing the results of the latest training cycle.

In Step 212, a new updated model is generated using the values from the gradient K-quant vectors for each vector position and the shape values used for that position for the previous model update calculation. In one or more embodiments, the number of instances of each bin index value are added to the shape parameter corresponding to that bin index value. Additionally, the number of instances of the bin index value added to the shape parameter and the total number of values are used to calculate a new q, which, in turn is used to calculate a new expected value for use at a given vector position in the new model update.

Continuing the above example of twenty client nodes and K of two, if the most recent cycle yielded two instances of bin index value one (which decodes to 0.5), and eighteen instances of negative one (which decodes to −0.5), then q=(1+2−1)/(1+1+20−2)=0.15. The expected value then becomes [(2×0.15)−1]=−0.7. One of ordinary skill in the art will appreciate that this value is different from the mean obtained using the same values, which would be:

(2+(−18))/2=−0.8.

In one or more embodiments, the above-described analysis is performed to determine an expected value for each vector position, and the results are used to form a new model update.

In Step 214, the new model update is distributed to the client nodes. In one or more embodiments, the client nodes each use the updated model to perform another training cycle, each using client data available to that client.

In Step 216, a determination is made as to whether the training has ended. In one or more embodiments, the training may end after a pre-determined number of cycles or epochs has occurred. Additionally or alternatively, training may end when a determination is made that the model has reached a desired level of ability to generalize to produce correct results from previously unseen inputs. In one or more embodiments, the training is complete, the process ends. In one or more embodiments, if training is not complete, then the method proceeds to Step 218.

In Step 218, a determination is made as to whether a cycle threshold has been reached. In one or more embodiments, if a cycle threshold has been reached, then the method returns to Step 202, a set of gradient K-quant vectors is received, and Step 204 is performed to generate an updated model using the initial shape parameters (i.e., equal to one). In one or more embodiments, if the cycle threshold has not been reached, the method continues to Step 220.

In Step 220, the shape parameters are updated. In one or more embodiments, for each gradient position, the number of instances of each bin index values in the new gradient K-quant vector are added to the shape parameter value for that bin index value to obtain the shape parameters for use in the next cycle for a given gradient position. In one or more embodiments, the method returns to Step 208, and the updated shape parameters for each position are stored. The method then repeats Steps 210-214 to generate and distribute a new model to the client nodes.

### Example

The above describes systems and methods for generating model updates used during training of a machine learning algorithm in a federated learning environment. Such embodiments are intended to scale for use in model training scenarios that produce gradient vectors with any number of gradient value elements (e.g., hundreds, thousands, millions, billions, etc.). However, for the sake of brevity and simplicity, consider the following scenario to illustrate the concepts described herein.

A model coordinator is configured to perform federated learning services in conjunction with four client nodes, with each node including a neural network with a number of layers between the input layer and the output layer. In such a scenario, an initial model is sent to the client nodes to begin a training cycle, along with a range of negative one to positive one, and a K value. Each client node executes a gradient descent algorithm to train the model on its own private data. The output of the training is a gradient vector that includes gradients corresponding to variables relevant to predicting an output based on input data.

Instead of the actual value of the gradients in the gradient vector, each client node is initially configured to send only the K-quant representation of the gradient vector values. The client nodes first normalize the gradient vector values to between negative one and positive one (i.e., within the range communicated to the client nodes by the model coordinator). Each client node uses the K value provided by the model coordinator to divide the range (also provided by the model coordinator) into equal sub-portions, each associated with a bin index value. The clients assess the gradient vector, and determine with sub-portion each value therein falls within. The bin index value associated with the sub-portion of the range within which the gradient vector value falls replaces the actual gradient vector value for each position in the gradient vector. This process happens on each of the four client nodes.

The following is an example for one (i.e., the same) gradient vector position from each of the client nodes.

Example gradient vector position values for each of the four client nodes:

{−0.47; −0.10; 0.84; 0.00}

The following are examples of how the client node would convert the gradient vector into a gradient K-quant vector for a variety of values of K. Note that although four examples of K are given to illustrate embodiments described herein, an actual training cycle would use a single K value communicated to all of the client nodes from the model coordinator, and a single range having minimum and maximum values. The range for these examples, as discussed above, is negative one to positive one.

If K is two, the range is divided into two bins with associated bin index values: [−1, 0] (bin index value=0) and [0, 1] (bin index value=1).

The client nodes thus determine the following gradient K-quant vector values for the position based on which bin each gradient value falls within: {0; 0; 1; 1}.

If K is four, the range is divided into four bins with associated bin index values: [−1, −0.5] (bin index value=0), [−0.5, 0] (bin index value=1), [0, 0.5] (bin index value=2), and [0.5, 1] (bin index value=3).

The client nodes thus determine the following gradient K-quant vector values for the position based on which bin each gradient value falls within: {1; 1; 3; 2}.

If K is eight, the range is divided into eight bins with associated bin index values: [−1, −0.75] (bin index value=0), [−0.75, −0.5] (bin index value=1), [−0.5, −0.25] (bin index value=2), [−0.25, 0] (bin index value=3), [0, 0.25] (bin index value=4), [0.25, 0.5] (bin index value=5), [0.5, 0.75] (bin index value=6), and [0.75, 1] (bin index value=7).

The client nodes thus determine the following gradient K-quant vector values for the position based on which bin each gradient value falls within: {2; 3; 7; 4}.

At this point, the client nodes transmit their respective gradient K-quant vectors to the central node. The central node receives the gradient K-quant vectors, and decodes them to find the bin index values, which are then used to find the associated mean of the upper and lower edge of the sun-portion of the range associated with the bin index values.

In the example where K is eight, the bins, again, are [−1, −0.75], [−0.75, −0.5], [−0.5, −0.25], [−0.25, 0], [0, 0.25], [0.25, 0.5], [0.5, 0.75], and [0.75, 1]. Thus, per bin, the mean values are [−0.875; −0.625; −0.375; −0.125; 0.125; 0.375; 0.625; 0.875]. Thus, using the bin index values of the gradient K-quant vector values for the example vector position from each of the client nodes (i.e., [2; 3; 7; 4]), the decoded gradient vector values for the position become:

[−0.375; −0.125; 0.875; −0.125]

Next, for this gradient vector position in the decoded gradient vector, the model coordinator, in the initial training cycle, takes the average of the values, as follows: [(−0.375)+(−0.125)+(0.875)+(−0.125)]/4=0.0625, which becomes the value for the position in the updated ML model to be distributed to the client nodes for the next cycle of ML model training. As additional examples, if K was 2, then similar analysis would yield a value of 0.0, and if K was 4, a similar analysis would yield a value of −0.125. The actual average of the original four values is 0.0675. Thus, as K increases, the result of the analysis gets closer to the actual mean value for the gradient vector position.

To perform the analysis, the model coordinator takes the set of values from the first cycle of training for a given gradient K-quant vector position from each of the four nodes, and performs a similar analysis to generate an updated model, which is distributed to the client nodes for the next cycle of training.

For the next cycle, the model coordinator again takes the set of values from the gradient K-quant vector position from the gradient K-quant vectors received from the client nodes after they complete the second cycle. Using this information, and the previous shape values of 1, q is calculated, and used to determine an expected value for each gradient position.

For the next cycle, the model coordinator again takes the set of values from the gradient K-quant vector position from the gradient K-quant vectors received from the client nodes after they complete the third cycle. Using this information, and the shape values from the previous cycle, q is calculated, and used to determine an expected value for each gradient position.

In one or more embodiments, similar calculations are performed for each cycle and each vector position to produce updated models after each cycle, until a cycle threshold is reached. In this example, empirical evidence has shown that a cycle threshold of ten results in stronger generalization for the model, as well as faster convergence times. Therefore, the process repeats, with updates to the shape values for 10 cycles. After the tenth cycle, the shape values are again set to one, and the process repeats for another 10 cycles. The training epoch is pre-set to last for 100 cycles, leading to 10 sets of 10 cycles using the described process to produce a final model for use by the client nodes to predict outcomes for the relevant scenario for which the training occurred.

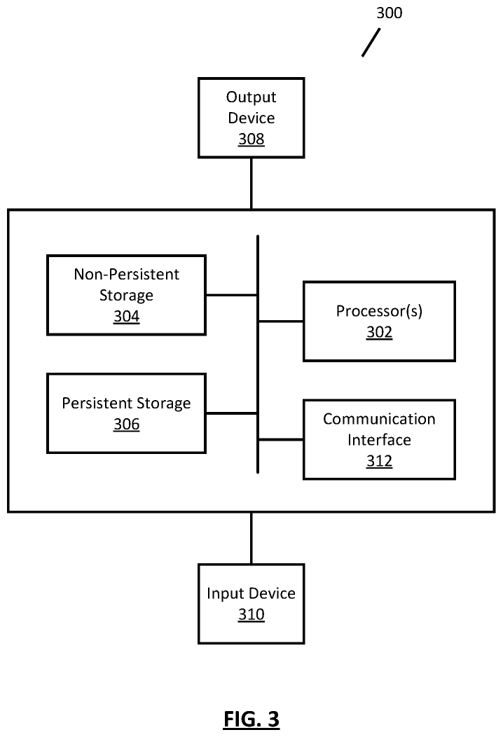

As discussed above, embodiments of the invention may be implemented using computing devices. FIG. 3 shows a diagram of a computing device in accordance with one or more embodiments of the invention. The computing device (300) may include one or more computer processors (302), non-persistent storage (304) (e.g., volatile memory, such as random access memory (RAM), cache memory), persistent storage (306) (e.g., a hard disk, an optical drive such as a compact disk (CD) drive or digital versatile disk (DVD) drive, a flash memory, etc.), a communication interface (312) (e.g., Bluetooth interface, infrared interface, network interface, optical interface, etc.), input devices (310), output devices (308), and numerous other elements (not shown) and functionalities. Each of these components is described below.

In one embodiment of the invention, the computer processor(s) (302) may be an integrated circuit for processing instructions. For example, the computer processor(s) may be one or more cores or micro-cores of a processor. The computing device (300) may also include one or more input devices (310), such as a touchscreen, keyboard, mouse, microphone, touchpad, electronic pen, or any other type of input device. Further, the communication interface (312) may include an integrated circuit for connecting the computing device (300) to a network (not shown) (e.g., a local area network (LAN), a wide area network (WAN) such as the Internet, mobile network, or any other type of network) and/or to another device, such as another computing device.

In one embodiment of the invention, the computing device (300) may include one or more output devices (308), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (302), non-persistent storage (304), and persistent storage (306). Many different types of computing devices exist, and the aforementioned input and output device(s) may take other forms.

The problems discussed above should be understood as being examples of problems solved by embodiments of the invention and the invention should not be limited to solving the same/similar problems. The disclosed invention is broadly applicable to address a range of problems beyond those discussed herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for model updating in a federated learning environment, the method comprising:
distributing, by a model coordinator, a current model to a plurality of client nodes;
receiving, by the model coordinator and in response to distributing the current model, a first set of gradient K-quant vectors, wherein each gradient K-quant vector of the first set of gradient K-quant vectors is received from one client node of the plurality of client nodes;
generating, by the model coordinator, a first updated model based on the first set of gradient K-quant vectors;
distributing the first updated model to the plurality of client nodes;
storing, by the model coordinator, a plurality of shape parameters;
receiving, by the model coordinator and in response to distributing the first updated model, a second set of gradient K-quant vectors, wherein each gradient K-quant vector of the second set of gradient K-quant vectors is received from one client node of the plurality of client nodes;
generating, by the model coordinator, a second updated model based on the second set of gradient K-quant vectors and the plurality of shape parameters; and
distributing the second updated model to the plurality of client nodes.

2. The method of claim 1, further comprising:
updating a first shape parameter of the plurality of shape parameters using a set of gradient K-quant values at a gradient K-quant vector position within the second set of gradient K-quant vectors to obtain an updated first shape parameter;
receiving, by the model coordinator and in response to distributing the second updated model, a third set of gradient K-quant vectors, wherein each gradient K-quant vector of the third set of gradient K-quant vectors is received from one client node of the plurality of client nodes; and
generating, by the model coordinator, a third updated model using at least the second set of gradient K-quant vectors and the updated first shape parameter.

3. The method of claim 2, further comprising:
making a determination, by the model coordinator and after distributing the second updated model, that a cycle threshold is reached;
discarding, based on the determination; and
using the plurality of shape parameters and a next set of gradient K-quant vectors from the plurality of client nodes to generate a next updated model.

4. The method of claim 1, wherein, before receiving the first set of gradient K-quant vectors, the method further comprises distributing, by the model coordinator and to the plurality of client nodes, a K value and a range, wherein the plurality of client nodes use the K value and the range to generate the first set of gradient K-quant vectors.

5. The method of claim 1, wherein, when the current model is an initial model, generating the first updated model comprises:
calculating an average gradient position value for each gradient position of the first updated model using the first set of gradient K-quant vectors.

6. The method of claim 1, further comprising, before generating the first updated model:
decoding each gradient K-quant vector of the first set of gradient K-quant vectors to obtain a plurality of bin index values.
wherein the model coordinator generates the first updated model using the plurality of bin index values.

7. The method of claim 6, wherein the plurality of bin index values are used to obtain a plurality of mean range values of a range associated with each of the plurality of bin index values.

8. A non-transitory computer readable medium comprising computer readable program code, which when executed by a computer processor enables the computer processor to perform a method for model updating in a federated learning environment, the method comprising:
distributing, by a model coordinator, a current model to a plurality of client nodes;
receiving, by the model coordinator and in response to distributing the current model, a first set of gradient K-quant vectors, wherein each gradient K-quant vector of the first set of gradient K-quant vectors is received from one client node of the plurality of client nodes;
generating, by the model coordinator, a first updated model based on the first set of gradient K-quant vectors;
distributing the first updated model to the plurality of client nodes;
storing, by the model coordinator, a plurality of shape parameters;
receiving, by the model coordinator and in response to distributing the first updated model, a second set of gradient K-quant vectors, wherein each gradient K-quant vector of the second set of gradient K-quant vectors is received from one client node of the plurality of client nodes;
generating, by the model coordinator, a second updated model based on the second set of gradient K-quant vectors and the plurality of shape parameters; and
distributing the second updated model to the plurality of client nodes.

9. The non-transitory computer readable medium of claim 8, wherein the method performed by executing the computer readable program code further comprises:
updating a first shape parameter of the plurality of shape parameters using a set of gradient K-quant values at a gradient K-quant vector position within the second set of gradient K-quant vectors to obtain an updated first shape parameter;
receiving, by the model coordinator and in response to distributing the second updated model, a third set of gradient K-quant vectors, wherein each gradient K-quant vector of the third set of gradient K-quant vectors is received from one client node of the plurality of client nodes; and
generating, by the model coordinator, a third updated model using at least the second set of gradient K-quant vectors and the updated first shape parameter.

10. The non-transitory computer readable medium of claim 9, wherein the method performed by executing the computer readable program code further comprises:
making a determination, by the model coordinator and after distributing the second updated model, that a cycle threshold is reached;
discarding, based on the determination; and
using the plurality of shape parameters and a next set of gradient K-quant vectors from the plurality of client nodes to generate a next updated model.

11. The non-transitory computer readable medium of claim 8, wherein, before receiving the first set of gradient K-quant vectors, the method further comprises distributing, by the model coordinator and to the plurality of client nodes, a K value and a range, wherein the plurality of client nodes use the K value and the range to generate the first set of gradient K-quant vectors.

12. The non-transitory computer readable medium of claim 8, wherein, when the current model is an initial model, generating the first updated model comprises:
calculating an average gradient position value for each gradient position of the first updated model using the first set of gradient K-quant vectors.

13. The non-transitory computer readable medium of claim 8, wherein the method performed by executing the computer readable program code further comprises, before generating the first updated model:
decoding each gradient K-quant vector of the first set of gradient K-quant vectors to obtain a plurality of bin index values.
wherein the model coordinator generates the first updated model using the plurality of bin index values.

14. The non-transitory computer readable medium of claim 13, wherein the plurality of bin index values are used to obtain a plurality of mean range values of a range associated with each of the plurality of bin index values.

15. A system for model updating in a federated learning environment, the system comprising:
a model coordinator, executing on a processor comprising circuitry, and configured to:
distribute a current model to a plurality of client nodes;
receive, in response to distributing the current model, a first set of gradient K-quant vectors, wherein each gradient K-quant vector of the first set of gradient K-quant vectors is received from one client node of the plurality of client nodes;
generate a first updated model based on the first set of gradient K-quant vectors;
distribute the first updated model to the plurality of client nodes;
store a plurality of shape parameters;
receive, in response to distributing the first updated model, a second set of gradient K-quant vectors, wherein each gradient K-quant vector of the second set of gradient K-quant vectors is received from one client node of the plurality of client nodes;
generate a second updated model based on the second set of gradient K-quant vectors and the plurality of shape parameters; and
distribute the second updated model to the plurality of client nodes.

16. The system of claim 15, wherein the model coordinator is further configured to:
update a first shape parameter of the plurality of shape parameters using a set of gradient K-quant values at a gradient K-quant vector position within the second set of gradient K-quant vectors to obtain an updated first shape parameter;
receive, in response to distributing the second updated model, a third set of gradient K-quant vectors, wherein each gradient K-quant vector of the third set of gradient K-quant vectors is received from one client node of the plurality of client nodes; and
generate a third updated model using at least the second set of gradient K-quant vectors and the updated first shape parameter.

17. The system of claim 16, wherein the model coordinator is further configured to:
making a determination, by the model coordinator and after distributing the second updated model, that a cycle threshold is reached;
discarding, based on the determination; and
using the plurality of shape parameters and a next set of gradient K-quant vectors from the plurality of client nodes to generate a next updated model.

18. The system of claim 15, wherein, before receiving the first set of gradient K-quant vectors, the model coordinator is further configured to distribute, to the plurality of client nodes, a K value and a range, wherein the plurality of client nodes use the K value and the range to generate the first set of gradient K-quant vectors.

19. The system of claim 15, further comprising, before generating the first updated model:
decoding each gradient K-quant vector of the first set of gradient K-quant vectors to obtain a plurality of bin index values.
wherein the model coordinator generates the first updated model using the plurality of bin index values.

20. The system of claim 19, wherein the plurality of bin index values are used to obtain a plurality of mean range values of a range associated with each of the plurality of bin index values.
